(19) United States
(12) Patent Application Publication
(10) Pub. No.: US 2019/0219732 A1
(43) Pub. Date: Jul. 18, 2019

(54) CORRECTING BOREHOLE SIGNAL CONTRIBUTIONS FROM NEUTRON-INDUCED GAMMA RAY SPECTROSCOPY LOGS

(71) Applicant: Halliburton Energy Services, Inc., Houston, TX (US)

(72) Inventor: James E. Galford, Missouri City, TX (US)

(21) Appl. No.: 15/578,205

(22) PCT Filed: Jun. 7, 2017
(86) PCT No.: PCT/US2017/036431

§ 371 Date: Nov. 29, 2017

Related U.S. Application Data
(60) Provisional application No. 62/347,247, filed on Jun. 8, 2016.

(51) Int. Cl. G01V 5/12; G01V 5/04; E21B 49/00; E21B 21/06; E21B 41/00

(52) U.S. Cl. CPC G01V 5/12; G01V 5/045; E21B 41/0092; E21B 21/06; E21B 49/005

(57) ABSTRACT

The subject technology relates to estimating borehole contributions to measured calcium and sulfur elemental yields by using a small number of mud properties available from wellsite mud reports at the time of logging. Neutron-induced gamma ray spectroscopy logs may be measured and, more specifically, estimating the borehole contributions to the measured calcium and sulfur elemental yields. The subject technology provides for predicting relative borehole yields as a function of borehole size and a set of properties that describe the composition of various complex drilling mud mixtures based on the elemental atomic number density for the drilling mud. The subject technology generates borehole bias vectors from analysis of the simulated tool responses, and applies a borehole bias vector to a relative elemental yield vector to correct a calcium yield and/or a sulfur yield. Other methods, systems, and computer-readable media are also disclosed.

### CROSS-REFERENCE TO RELATED APPLICATIONS

The present application is a National Stage entry of and claims priority to PCT Application No. PCT/US2017/036431, entitled “CORRECTING BOREHOLE SIGNAL CONTRIBUTIONS FROM NEUTRON-INDUCED GAMMA RAY SPECTROSCOPY LOGS,” filed on Jun. 7, 2017, which claims the benefit of priority under 35 U.S.C. § 119 from U.S. Provisional Patent Application No. 62/347,247, entitled “CORRECTING BOREHOLE SIGNAL CONTRIBUTIONS FROM NEUTRON-INDUCED GAMMA RAY SPECTROSCOPY LOGS,” filed on Jun. 8, 2016, the disclosures of which are hereby incorporated by reference in their entirety for all purposes.

### TECHNICAL FIELD

The present disclosure relates to neutron-induced gamma ray spectroscopy logs, and more particularly to correcting borehole signal contributions from neutron-induced gamma ray spectroscopy logs.

### BACKGROUND

Geochemical logs produced by neutron-induced gamma ray spectroscopy are intended to provide elemental weight concentrations of earth formations, which are useful to evaluate the mineralogy of petroleum reservoirs. Drilling mud and certain mud additives contained within the borehole may contain appreciable amounts of chemical compounds comprised of elements, which are important to evaluating the reservoir mineralogy. The presence of the chemical compounds in the borehole leads to a bias of the measured formation elemental concentrations. Examples of mud additives that can bias measured elemental concentrations are: potassium chloride, barite, hematite, manganese tetroxide, and alumino-silicate viscosifiers.

### BRIEF DESCRIPTION OF THE DRAWINGS

The following figures are included to illustrate certain aspects of the implementations, and should not be viewed as exclusive implementations. The subject matter disclosed is capable of considerable modifications, alterations, combinations, and equivalents in form and function, as will occur to those skilled in the art and having the benefit of this disclosure.

FIG. 1 illustrates an example process of correcting borehole signal contributions from neutron-induced gamma ray spectroscopy logs.

FIG. 2A illustrates a plot of an example of consolidated borehole calcium bias results versus simulated mud calcium atomic number densities.

FIG. 2B illustrates a plot of an example of extrapolated data points indicating a linear relationship between borehole calcium bias results and simulated mud calcium atomic number densities.

FIG. 3A illustrates a plot of an example of consolidated borehole sulfur bias results versus simulated mud sulfur atomic number densities.

FIG. 3B illustrates a plot of an example of extrapolated data points indicating a linear relationship between borehole sulfur bias results and simulated mud sulfur atomic number densities.

FIG. 4 illustrates an example of a section of a spectroscopy log from an elemental analysis system implementing the methods and processes described herein.

FIG. 5 illustrates an exemplary drilling assembly for implementing the processes described herein.

FIG. 6 illustrates a wireline system suitable for implementing the processes described herein.

FIG. 7 is a block diagram illustrating the example logging device and server according to certain aspects of the disclosure.

FIG. 8 is a block diagram illustrating an example computer system with which the client of FIG. 7 can be implemented.

### DETAILED DESCRIPTION

The subject technology relates to estimating borehole contributions to measured calcium and sulfur elemental yields by using a small number of mud properties available from wellsite mud reports at the time of logging. The present application relates to neutron-induced gamma ray spectroscopy logs and, more specifically, estimating the borehole contributions to the measured calcium and sulfur elemental yields. Uniquely, the methods and algorithms described herein predict relative borehole yields as a function of borehole size and a set of properties that describe the composition of various complex drilling mud mixtures.

The disclosed system addresses a problem in traditional elemental weight concentration analyses by neutron-induced gamma ray spectroscopy systems tied to computer technology, namely the technical problem of obtaining an accurate interpretation of elemental concentrations in the subterranean formation. To accurately interpret the reservoir mineralogy, the measured elemental weight concentrations should be unbiased from signals that arise within the borehole and are unrelated to the minerals contained in the subterranean formation. The presence of the chemical compounds in the borehole leads to a bias of the measured formation elemental relative yields, which may be removed to obtain an accurate interpretation. Borehole contributions from mud additives in the past have relied on comparisons of elemental yields from the geochemical tool with other logging measurements. Contributions from the potassium, sulfur, iron, manganese, and aluminum contained in these additives can usually be quantified by comparing the measured elemental concentrations with other measurements such as neutron, density and photoelectric effect logs. For example, gamma ray, neutron, density, and photoelectric logs may be used to identify zones in a well where no minerals containing aluminum, such as clay or feldspars are expected. An appreciable aluminum reading in these zones would highlight a borehole aluminum bias. A similar technique cannot always be used to detect a borehole calcium bias in all cases. If the logged interval consisted of calcium-bearing formations, such as limestone, dolomite, or anhydrite, it would be difficult to quantify a borehole calcium bias by comparison with other logs. Even in situations where the logged interval spans carbonate rocks and clay-rich shaley formations, it may be a challenge to identify borehole calcium bias because shale formations sometimes contain small amounts of calcium minerals that may obscure a borehole calcium bias. The advent of calcium-weighted oil-based muds is problematic because the contribution cannot be determined through comparisons to other measurements in cases where the logged interval spans only carbonate formations.

The present disclosure provides for the estimation of borehole corrections for calcium and sulfur in wells drilled with calcium-weighted oil- or water-based muds. In addition, the subject technology may also be applied to estimate borehole sulfur corrections in wells drilled with oil- or water-based muds that are weighted with barite. Even though the subject technology is adapted for open hole geochemical logs, it may also be adapted for use with cased hole logs to compensate for the presence of casing fluids that contain calcium and/or sulfur chemical compounds. The subject technology may be adapted for use with a neutron-induced gamma ray spectroscopy tool that uses a chemical neutron source. However, it can also be used with similar tools whose source of neutrons is a neutron generator.

The disclosed system further provides improvements to the functioning of the computer itself because it saves data storage space, reduces system loading times and reduces the cost of system resources. Specifically, the tool response modeling helps reduce the system loading latency by producing borehole bias predictive models that provide a borehole bias vector for a given borehole diameter without the need to process complex computations of atomic number densities while logging and/or after the logging has been completed. The borehole bias vector can be stored and indexed by mud type classification, which helps to reduce both data storage space and the cost of system resources.

The subject technology provides several advantages over the traditional elemental weight concentration analyses by neutron-induced gamma ray spectroscopy systems. The disclosed system provides a mechanism to estimate the borehole bias correction for calcium and sulfur in cases where the formations in the logged interval contain these elements. In a case where these elements are biased by a borehole signal, an operator would be precluded from identifying the bias and quantifying the magnitude of the bias. Probabilistic modeling such as Monte Carlo modeling increases efficiency by assembling a considerably large database of tool responses from which bias estimators can be characterized as opposed to a manual method that relies on laboratory experiments. The disclosed system can be applied to develop borehole bias estimators for any type (or class) of mud system that can potentially bias elemental responses that are of interest for formation evaluation.

Chemical compounds in the drilling mud can affect the response of neutron-induced gamma ray spectroscopy logging tools by producing a signal that adds to the signal produced from nuclear reactions occurring in the surrounding earth formation, which is of interest for the purposes of petrophysical mineralogy evaluations. Some form of a weighted least-squares fitting method is usually applied to measured gamma ray spectra to obtain a vector of relative elemental yields (γ) that will be biased to some extent by the presence of borehole signals. If the fitted relative elemental yields are used to obtain elemental concentrations for the formation, the results will be influenced by the borehole signal bias contained in the relative elemental yields. Thus, to obtain unbiased formation elemental concentrations, the borehole bias may be subtracted from the fitted relative elemental yields. A borehole bias-corrected vector of relative elemental yields (γ_{c}) is computed by subtracting a borehole bias vector (b) from the fitted relative elemental yields:

γ_{c}=γ−b Equation (1)

In a traditional approach, the borehole bias-corrected vector may be derived from a pulsed neutron-induced gamma ray spectroscopy tool response model, in which absolute elemental yields are obtained from individual responses produced by geometrical regions, such as the tool pressure housing, borehole fluid, casing, cement, and the earth formation. Responses from the geometrical regions are combined according to corresponding regional partition factors to obtain the observed absolute elemental yields.

In one or more implementations, the subject technology predicts relative borehole yields as a function of borehole size and a set of properties that describe the composition of various complex drilling mud mixtures. Borehole bias manifest itself as an offset with counting statistics. Because of this, the physical lower limit of zero for bias-corrected relative yields can be safeguarded when applying the bias correction. For example, the bias-corrected calcium relative yield (γ_{Ca}_{_}_{corr}) is constrained according to:

γ_{Ca}_{_}_{corr}=max(0,γ_{Ca}−b_{Ca}) Equation (2)

where γ_{Ca} is a fitted calcium yield and b_{Ca} is a calcium relative yield borehole bias.

In one or more implementations, components of the borehole bias vector are dependent on the composition of the drilling mud. Likewise, in some implementations, logs recorded in the same formation and with the same drilling mud, but with different borehole diameters, can be affected dissimilarly. Thus, borehole geometry also affects the borehole bias vector components.

The subject technology relates to a process to estimate calcium and sulfur components of the borehole bias vector for calcium-weighted oil-based muds. The process may also be applicable to estimating borehole sulfur bias for barite-weighted oil- and water-based mud systems. Further, the process may be applied to other mud systems containing other chemical compounds such as hematite or manganese tetroxide that may create a borehole bias for other elements important to petrophysical analyses.

In some implementations, the process includes three steps. For example, a first step correlates a small number of descriptive drilling mud properties to elemental atomic number densities for a class of drilling mud (e.g., calcium-weighted oil-based mud). In a second step, probabilistic modeling (e.g., Monte Carlo simulation) is used simulate tool responses for a variety of logging conditions (e.g., formation mineralogy, borehole diameter, and several exemplary mud compositions for a chosen mud system). In a third step, relative yield bias estimators are constructed from analysis of the simulated tool responses. This process may be carried out in real-time as logging is occurring. Alternatively, the process may be applied to logging data after having been collected.

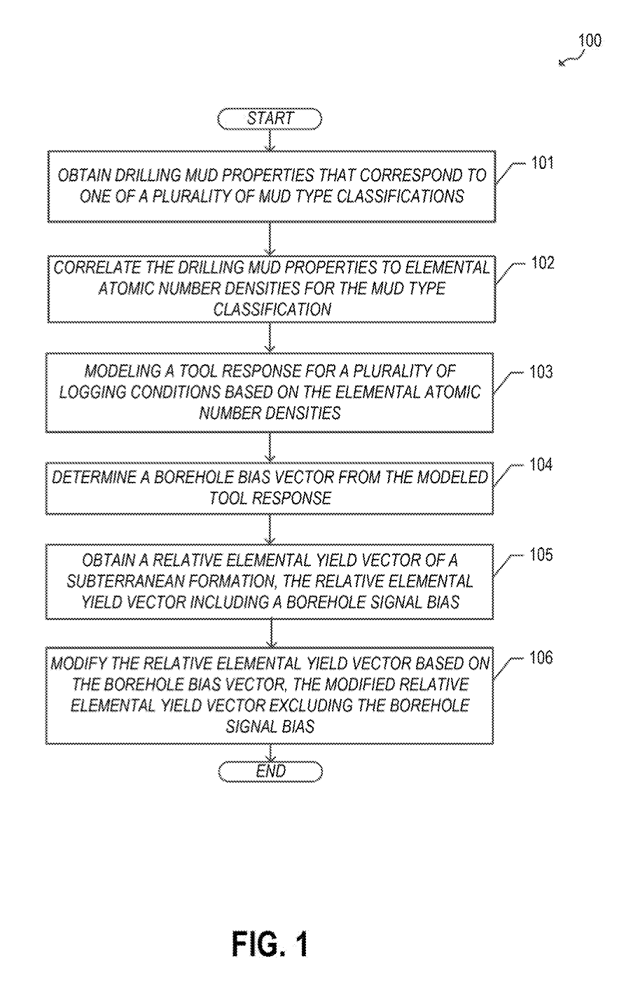

FIG. 1 illustrates an example process 100 of correcting borehole signal contributions from neutron-induced gamma ray spectroscopy logs. The process 100 begins by proceeding from beginning step 101. In step 101, drilling mud properties that correspond to one of a plurality of mud type classifications are obtained. In some aspects, the drilling mud properties may be obtained from vendor-supplied mud reports. The parameters may include density of the mud mixture, the weight percent concentration of calcium chloride brine, the fractional volume of solids in the mud, the fractional volume of calcium chloride brine in the mud, and the oil fraction from the oil-to-water ratio. The parameters may also include the density quantities of base oil and constituent solids.

Next, in step 102, the drilling mud properties are correlated to elemental atomic number densities for the mud type classification. These drilling mud properties lead to the development of algorithms to calculate the atomic number density of calcium and sulfur atoms contained in calcium-weighted oil-based and/or water-based mud mixtures. The mud type classifications may include calcium-weighted oil-based mud mixtures, calcium-weighted water-based mud mixtures, barite-weighted oil-based mud mixtures, and barite-weighted water-based mud mixtures.

For example, in a calcium-weighted oil-based mud, the calculations in the step 102 assume (1) the mud mixture has a liquid phase and a solids phase; (2) the liquid phase is an immiscible mixture of oil and calcium chloride brine; and (3) the solids phase consists of a mixture of calcite and barite. Then, only a small number of mud properties are needed to estimate atomic number densities of calcium and sulfur in the mud: (1) density of the mud mixture (ρ_{mud}) (g/cm³), (2) the weight percent concentration of the calcium chloride brine (C_{CaCl2}_{_}_{brine}); (3) the fractional volume of solids in the mud (V_{solids}); (4) the fractional volume of calcium chloride brine in the mud (V_{brine}); and (5) the oil fraction from the oil-to-water ration (Fₒᵢₗ). Densities of the base oil and constituent solids are assumed to be known quantities. The following equations illustrate how these quantities are used to obtain calcium and sulfur atomic number densities (N_{Ca} and N_{S}, respectively) (atoms/cm³) for the mud mixture.

$$\begin{matrix}{ρ}_{liq} = {F}_{oil} {ρ}_{base \_ oil} + ( 1 - {F}_{oil} ) {ρ}_{CaCl 2 \_ brine} & Equation ( 3 ) \\ {ρ}_{solids} = \frac{{ρ}_{mud} - ( 1 - {V}_{solids} ) {ρ}_{liq}}{{V}_{solids}} & Equation ( 4 ) \\ {C}_{CaCl 2} = \frac{{V}_{brine} {ρ}_{CaCl 2 \_ brine}}{{ρ}_{mud}} & Equation ( 5 ) \\ {C}_{oil} = \frac{( 1 - {V}_{brine} - {V}_{solids} ) {ρ}_{base \_ oil}}{{ρ}_{mud}} 100 & Equation ( 6 ) \\ {F}_{calcite} = \frac{{ρ}_{solids} - {ρ}_{barite}}{{ρ}_{calcite} - {ρ}_{barite}} & Equation ( 7 ) \\ {W}_{calcite} = \frac{{F}_{calcite} {ρ}_{calcite}}{{ρ}_{solids}} & Equation ( 8 ) \\ {W}_{barite} = \frac{( 1 - {F}_{calcite} ) {ρ}_{barite}}{{ρ}_{solids}} & Equation ( 9 ) \\ {C}_{calcite} = min ( ( 100 - {C}_{oil} - {C}_{CaCl 2 \_ brine} ) {F}_{calcite} , 100 - {C}_{oil} - \frac{{V}_{brine} {ρ}_{CaCl 2 \_ brine}}{{ρ}_{mud}} 100 ) & Equation ( 10 ) \\ {C}_{barite} = max ( 0 , ( 100 - {C}_{oil} - {C}_{CaCl 2 \_ brine} ) ( 1 - {F}_{calcite} ) ) & Equation ( 11 ) \\ {N}_{Ca} = \frac{{N}_{Av} {ρ}_{mud} ( 0.3611 {C}_{CaCl 2} + 0.4005 {C}_{calcite} ) \text{/} 100}{40.078} & Equation ( 12 ) \\ {N}_{S} = \frac{{N}_{Av} {ρ}_{mud} 0.1374 {C}_{barite} \text{/} 100}{32.065} & Equation ( 13 )\end{matrix}$$

where:
ρ_{liq} is the liquid phase density in g/cm³.
ρ_{base}_{_}ₒᵢₗ is the base oil density in g/cm³.
ρ_{CaCl2}_{_}_{brine} is the calcium chloride brine density in g/cm³, a function of C_{CaCl2}_{_}_{brine}.
ρ_{solids} is the mud solids density in g/cm³.
C_{CaCl2} is the weight percentage of calcium chloride in the mud.
Cₒᵢₗ is the weight percentage of base oil in the mud.
F_{calcite} is the volume fraction of calcite in the mud solids.
ρ_{barite} is the density of barite in g/cm³.
ρ_{calite} is the density of calcite in g/cm³.
W_{calcite} is the weight fraction of calcite in the mud solids.
W_{barite} is the weight fraction of barite in the mud solids.
C_{calcite} the weight percentage of calcite in the mud.
C_{barite} the weight percentage of barite in the mud.
N_{Av} is Avogadro's number in atoms/mole.
N_{Ca} is the number density of calcium atoms in the mud in atoms/cm³.
N_{S} is the number density of sulfur atoms in the mud in atoms/cm³.

A similar algorithm was developed to calculate the atomic number density of sulfur atoms for barite-weighted oil-based muds that comprise a ternary mixture of oil, sodium chloride brine, and barite. In this case, the mud properties needed to estimate atomic number density of sulfur in the mud include: (1) mud density, (2) weight percent concentration of the sodium chloride brine (C_{NaCl}_{_}_{brine}), and (3) the oil-to-water ratio.

$$\begin{matrix}{ρ}_{liq} = {F}_{oil} {ρ}_{base \_ oil} + ( 1 - {F}_{oil} ) {ρ}_{NaCl \_ brine} & Equation ( 14 ) \\ {F}_{liq} = \frac{{ρ}_{barite} - {ρ}_{mud}}{{ρ}_{barite} - {ρ}_{liq}} & Equation ( 15 ) \\ {W}_{barite} = \frac{max ( 1 - {F}_{liq} , 0 ) {ρ}_{barite}}{{ρ}_{mud}} & Equation ( 16 ) \\ {N}_{S} = \frac{{N}_{Av} {ρ}_{mud} 0.1374 {W}_{barite}}{32.065} & Equation ( 17 )\end{matrix}$$

where:
ρ_{NaCl}_{_}_{brine} is the sodium chloride brine density in g/cm³, a function of C_{NaCl}_{_}_{brine}.
F_{liq} is the liquid phase volume fraction.

Similarly, an algorithm to calculate the atomic number density of sulfur atoms was developed for barite-weighted water-based muds comprising of sodium chloride brine, barite, and bentonite. In this case, the mud properties needed to estimate atomic number density of sulfur in the mud include: (1) mud density and (2) weight percent concentration of the sodium chloride brine.

$$\begin{matrix}{F}_{brine} = max ( ( {ρ}_{mud} {C}_{brine} \text{/} {ρ}_{NaCl \_ brine} ) \text{/} 100 , ( {ρ}_{mud} - {ρ}_{bentonite} ) \text{/} ( {ρ}_{NaCl \_ brine} - {ρ}_{bentonite} ) ) & Equation ( 18 ) \\ {F}_{solids} = max ( 1 - {F}_{brine} , 0 ) & Equation ( 19 ) \\ {ρ}_{solids} = \frac{{ρ}_{mud} - ( 1 - {F}_{solids} ) {ρ}_{NaCl \_ brine}}{{F}_{solids}} & Equation ( 20 ) \\ {F}_{barite} = max ( 1 - ( {ρ}_{solids} - {ρ}_{barite} ) \text{/} ( {ρ}_{bentonite} - {ρ}_{barite} ) , 0 ) & Equation ( 21 ) \\ {C}_{barite} = max ( ( 100 - {C}_{NaCl \_ brine} ) {F}_{barite} {ρ}_{barite} \text{/} {ρ}_{solids} , 0 ) & Equation ( 22 ) \\ {N}_{S} = \frac{{N}_{Av} {ρ}_{mud} 0.1374 {C}_{barite} \text{/} 100}{32.065} & Equation ( 23 )\end{matrix}$$

where:

ρ_{NaCl}_{_}_{brine} is the sodium chloride brine density in g/cm³, a function of C_{NaCl}_{_}_{brine}.
C_{brine} is the weight percentage of brine in the mud, as a function of ρ_{mud}.
F_{brine} is the volume fraction of brine in the mud solids.
F_{solids} is the volume fraction of the mud solids.
F_{barite} is the volume fraction of barite in the mud solids.
ρ_{bentonite} is the density of bentonite in g/cm³.

Subsequently, in step 103, a tool response is modeled for a plurality of logging conditions to produce a borehole bias predictive model based on the elemental atomic number densities. In the step 103, databases of Monte Carlo simulated responses for calcium-weighted oil-based muds and barite-weighted oil- and water-based muds may be used to develop a modeling program for each mud type classification in a variety of configurations including formation mineralogy, formation porosity, and borehole diameter. A base case (e.g., no borehole bias) and several additional cases involving different mud mixtures (e.g., combinations of mud properties) may then be simulated for each mud type classification.

Next, in step 104, a borehole bias vector is determined from the modeled tool response. In one example of implementing one of the borehole bias predictive models, the simulations may include borehole diameters in a range of 6 inches to 18 inches, and mud densities in a range of 6 lbm/gal to 18 lbm/gal. For each simulation, a borehole bias vector was calculated by imposing the condition that the formation elemental concentrations derived from the bias-corrected relative yields matched the corresponding base case.

Subsequently, in step 105, a relative elemental yield vector of a subterranean formation is obtained. In some aspects, the relative elemental yield vector includes a borehole signal bias. In one or more aspects, one or more elemental yield values in the relative elemental yield vector are biased by the borehole signal bias. To obtain unbiased elemental yields, the borehole bias signal may need to be subtracted from the relative elemental yield vector.

Next, in step 106, the relative elemental yield vector is modified based on the borehole bias vector. In some aspects, the modified elemental yield vector excludes the borehole signal bias. In this respect, the modified elemental yield vector allows for a bias-corrected calcium concentration and/or a bias-corrected sulfur concentration to be computed.

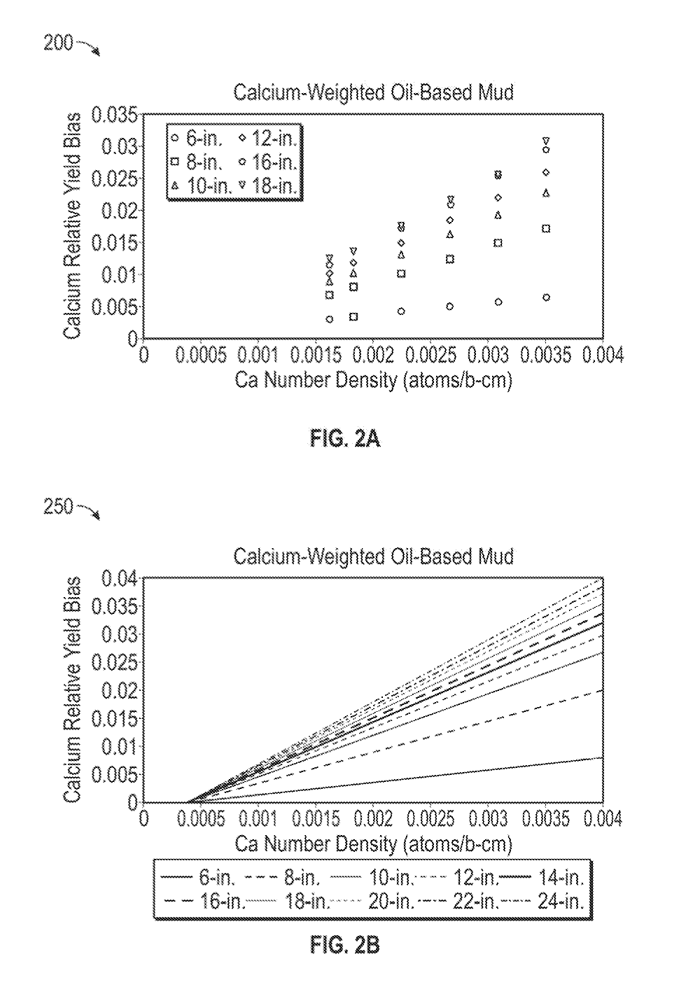

FIG. 2A illustrates a plot 200 of an example of consolidated borehole calcium bias results versus simulated mud calcium atomic number densities. The plot 200 may be generated from Monte Carlo simulations for calcium-weighted oil-based mud systems. A linear relationship represents the data for each borehole diameter. The simulated results were used to derive a bias estimator algorithm to emulate the calcium relative yield bias by smoothly varying parameters describing a linear relationship between calcium relative yield bias and mud calcium atomic number density as a function of borehole diameter.

FIG. 2B illustrates a plot 250 of an example of extrapolated data points indicating a linear relationship between borehole calcium bias results and simulated mud calcium atomic number densities. As shown in FIG. 2B, the bias estimator algorithm was extrapolated to support borehole diameters in a range of 6 inches to 24 inches. For example, for a borehole diameter of 18 inches, the borehole calcium bias can be about 0.035 when the mud calcium atomic density is about 0.004 atoms/b-cm.

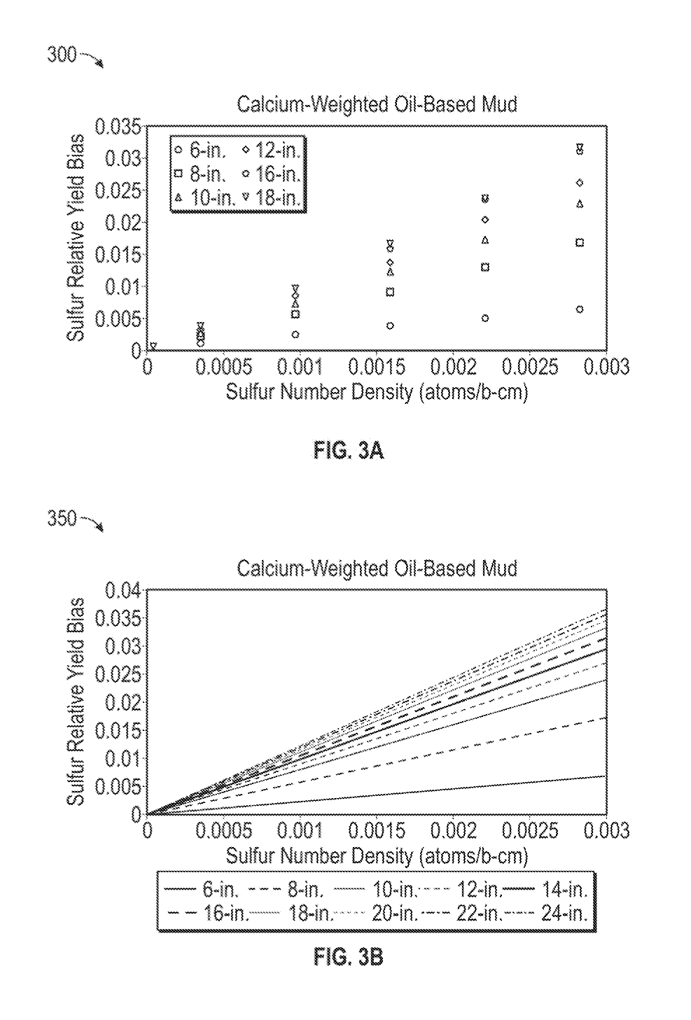

FIG. 3A illustrates a plot 300 of an example of consolidated borehole sulfur bias results versus simulated mud sulfur atomic number densities. Calcium-weighted oil-based mud systems may also include barite depending on the composition of the mud. The barite can produce a borehole sulfur bias. As shown in FIG. 3A, linear trends among the data project through the origin which corresponds to a mud mixture that does not contain any barite.

FIG. 3B illustrates a plot 350 of an example of extrapolated data points indicating a linear relationship between borehole sulfur bias results and simulated mud sulfur atomic number densities. The estimator algorithm, shown in FIG. 3B, was devised to emulate the sulfur relative yield bias by smoothly varying the slope of linear functions between the sulfur relative yield bias and mud sulfur atomic number density as a function of borehole diameter.

### Examples

The algorithms for the borehole bias estimators were implemented into one or more models for purposes of testing and validation on actual field log examples. The borehole bias estimators have been successfully tested on a number of calcium-weighted oil-based mud log examples from one or more geographical regions. The population of test cases include boreholes whose diameters are in a range of about 5.875 inches to about 16 inches, and included mud weights in a range of about 8.82 lbm/gal to about 13.37 lbm/gal.

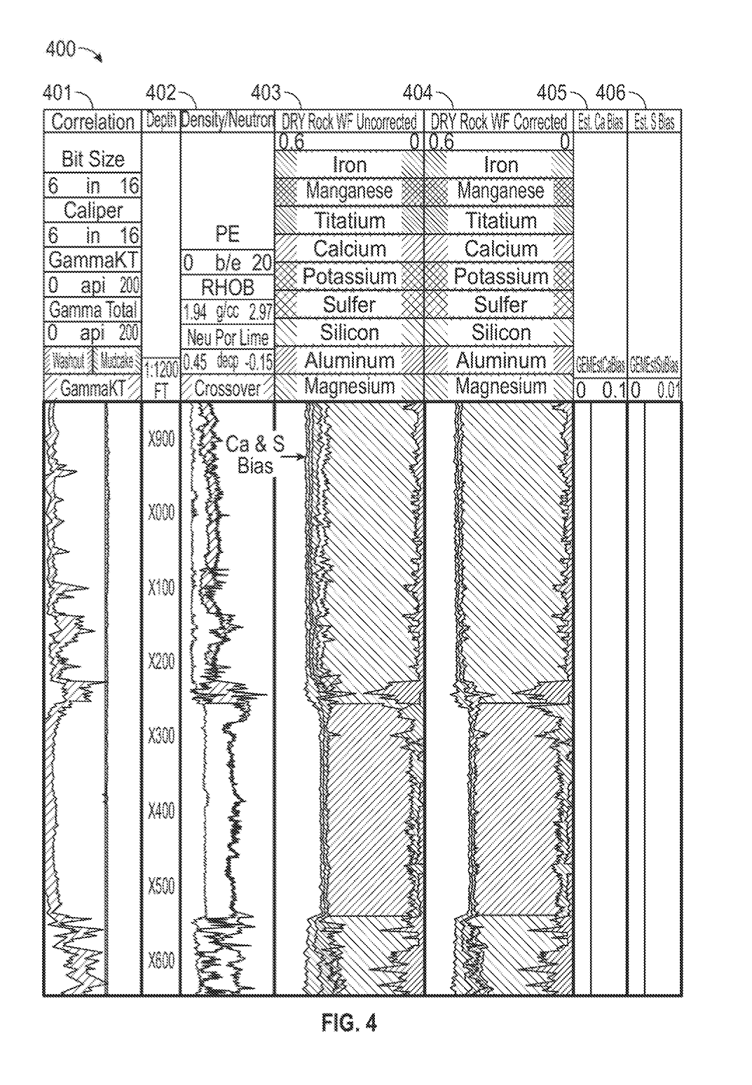

FIG. 4 illustrates an example of a section of a spectroscopy log 400 from an elemental analysis system implementing the methods and processes described herein. In this example, the well was drilled with a 12.25-inch drill bit and 10.43 lbm/gal calcium-weighted oil-based mud. The liquid phase comprised a 31.6 wt % CaCl₂ brine and diesel in an oil-to-water ratio of 80:20. Overall, the mud mixture was comprised of 67% diesel, 17% CaCl₂ brine, and 16% solids by volume according to the mud report.

Track I (e.g., 401) shows total gamma ray and gamma ray less uranium curves from a natural gamma ray spectroscopy log. Also presented in Track 1 are bit size and caliper traces, with shading to highlight mudcake and borehole washout. Track II (e.g., 402) contains bulk density, photoelectric, and neutron porosity logs. The neutron porosity and bulk density curves are presented on compatible limestone porosity scales. Uncorrected dry rock elemental weight fractions obtained with a neutron-induced gamma ray spectroscopy tool are shown in Track III (e.g., 403). Track IV (e.g., 404) contains dry rock elemental weight fractions after correction for borehole calcium and sulfur bias. Track V (e.g., 405) shows the borehole calcium relative yield bias and Track VI (e.g., 406) shows the borehole sulfur relative yield bias predicted by the bias estimators. For logging conditions in this well, estimated borehole calcium bias was about 0.019 relative yield units and the borehole sulfur bias was about 0.016 relative yield units.

The influence of calcium in the borehole produces an observable, somewhat constant calcium signal in the sand at the upper portion of the logged interval. The presence of the calcium in this interval would imply the presence of a calcium-bearing mineral, which is not substantiated by the photoelectric log in Track III (e.g., 403). Similarly, a small amount of sulfur is also noticed in Track II (e.g., 402) in the same interval, which highlights the influence of borehole sulfur. Track IV (e.g., 404) shows elemental concentrations, which are consistent with the other logs, obtained when the excess calcium and sulfur relative yield contributions are removed.

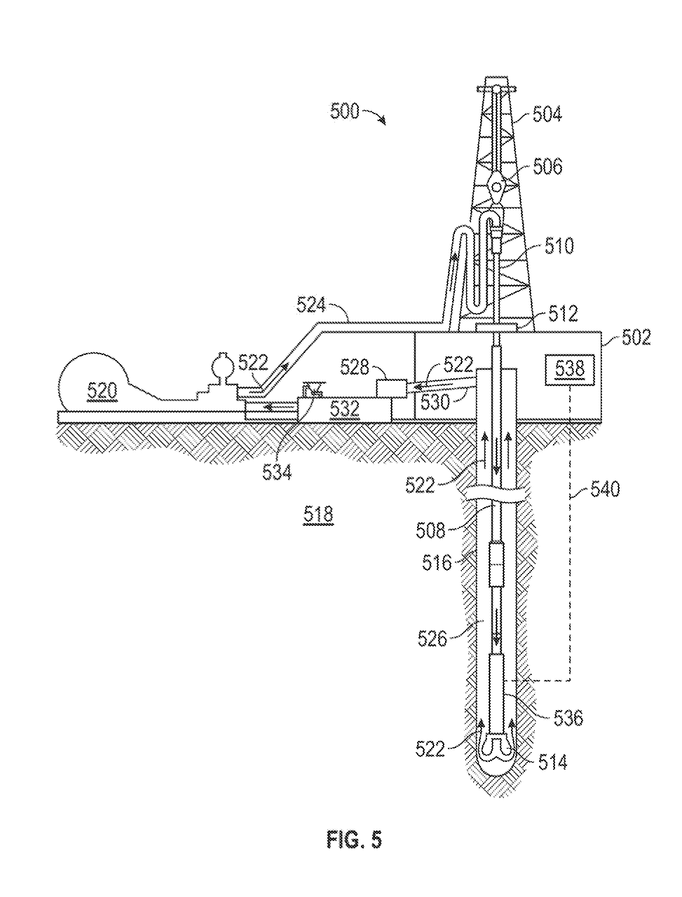

FIG. 5 illustrates an exemplary drilling assembly 500 for implementing the logging analysis methods described herein. It should be noted that while FIG. 5 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 500 may include a drilling platform 502 that supports a derrick 504 having a traveling block 506 for raising and lowering a drill string 508. The drill string 508 may include, but is not limited to, drill pipe and coiled tubing, as generally known to those skilled in the art. A kelly 510 supports the drill string 508 as it is lowered through a rotary table 512. A drill bit 514 is attached to the distal end of the drill string 508 and is driven either by a downhole motor and/or via rotation of the drill string 508 from the well surface. As the bit 514 rotates, it creates a wellbore 516 that penetrates various subterranean formations 518. Along the drill string 508 logging while drilling (LWD) or measurement while drilling (MWD) equipment 536 is included.

In the subject technology, the LWD/MWD equipment 536 may be capable of logging analysis of the subterranean formation 518 proximal to the wellbore 516. The LWD/MWD equipment 536 may transmit the measured data to a processor 538 at the surface wired or wirelessly. Transmission of the data is generally illustrated at line 540 to demonstrate communicable coupling between the processor 538 and the LWD/MWD equipment 536 and does not necessarily indicate the path to which communication is achieved.

A pump 520 (e.g., a mud pump) circulates drilling mud 522 through a feed pipe 524 and to the kelly 510, which conveys the drilling mud 522 downhole through the interior of the drill string 508 and through one or more orifices in the drill bit 514. The drilling mud 522 is then circulated back to the surface via an annulus 526 defined between the drill string 508 and the walls of the wellbore 516. At the surface, the recirculated or spent drilling mud 522 exits the annulus 526 and may be conveyed to one or more fluid processing unit(s) 528 via an interconnecting flow line 530. After passing through the fluid processing unit(s) 528, a “cleaned” drilling mud 522 is deposited into a nearby retention pit 532 (i.e., a mud pit). While illustrated as being arranged at the outlet of the wellbore 516 via the annulus 526, those skilled in the art will readily appreciate that the fluid processing unit(s) 528 may be arranged at any other location in the drilling assembly 500 to facilitate its proper function, without departing from the scope of the scope of the disclosure.

Chemicals, fluids, additives, and the like may be added to the drilling mud 522 via a mixing hopper 534 communicably coupled to or otherwise in fluid communication with the retention pit 532. The mixing hopper 534 may include, but is not limited to, mixers and related mixing equipment known to those skilled in the art. In other embodiments, however, the chemicals, fluids, additives, and the like may be added to the drilling mud 522 at any other location in the drilling assembly 500. In at least one embodiment, for example, there may be more than one retention pit 532, such as multiple retention pits 532 in series. Moreover, the retention pit 532 may be representative of one or more fluid storage facilities and/or units where the chemicals, fluids, additives, and the like may be stored, reconditioned, and/or regulated until added to the drilling mud 522.

The processor 538 may be a portion of computer hardware used to implement the various illustrative blocks, modules, elements, components, methods, and algorithms described herein. The processor 538 may be configured to execute one or more sequences of instructions, programming instances, or code stored on a non-transitory, computer-readable medium. The processor 538 can be, for example, a general purpose microprocessor, a microcontroller, a digital signal processor, an application specific integrated circuit, a field programmable gate array, a programmable logic device, a controller, a state machine, a gated logic, discrete hardware components, an artificial neural network, or any like suitable entity that can perform calculations or other manipulations of data. In some embodiments, computer hardware can further include elements such as, for example, a memory (e.g., random access memory (RAM), flash memory, read only memory (ROM), programmable read only memory (PROM), erasable programmable read only memory (EPROM)), registers, hard disks, removable disks, CD-ROMS, DVDs, or any other like suitable storage device or medium.

Executable sequences described herein can be implemented with one or more sequences of code contained in a memory. In some embodiments, such code can be read into the memory from another machine-readable medium. Execution of the sequences of instructions contained in the memory can cause a processor 538 to perform the process steps described herein. One or more processors 538 in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and/or software.

As used herein, a machine-readable medium will refer to any medium that directly or indirectly provides instructions to the processor 538 for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM.

In one or more implementations, the drilling assembly 500 involves drilling the wellbore 516 while the logging measurements are made with the LWD/MWD equipment 536. More generally, the methods described herein involve introducing a logging tool into the wellbore where the logging tool may be an LWD logging tool, a MWD logging tool, a wireline logging tool, slickline logging tool, and the like. In one or more implementations, the logging tool is integrated with a formation testing tool such that both tools are introduced into the wellbore. Alternatively, the logging tool may be an elemental analysis tool, where the elemental analysis tool is a logging-while-drilling or measurement-while-drill tool, and the methods and processes described herein may be implemented while drilling a portion of the wellbore.

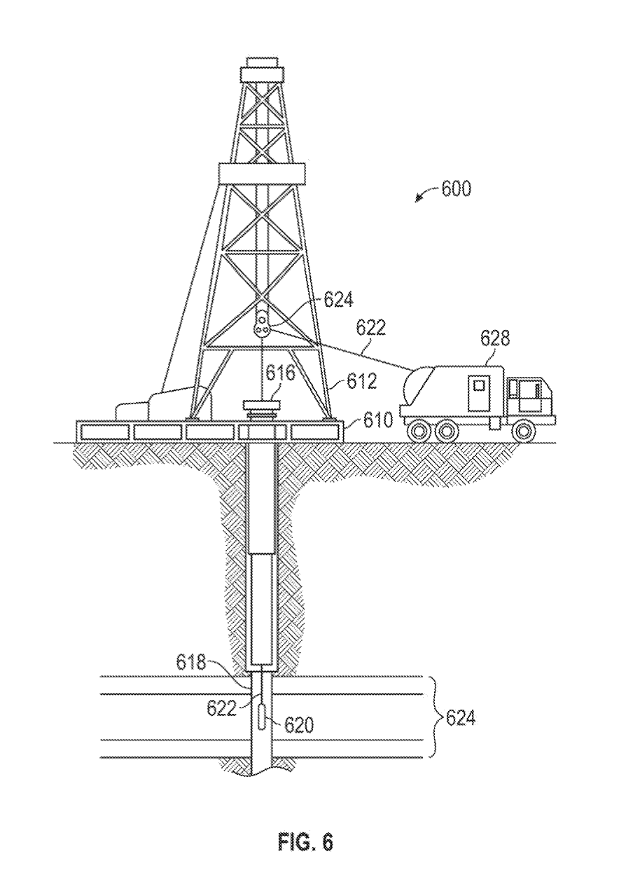

FIG. 6 illustrates a logging assembly 600 having a wireline system suitable for implementing the logging analysis methods described herein. As illustrated, a platform 610 may be equipped with a derrick 612 that supports a hoist 614. Drilling oil and gas wells, for example, are commonly carried out using a string of drill pipes connected together so as to form a drilling string that is lowered through a rotary table 616 into a wellbore 618. Here, it is assumed that the drilling string has been temporarily removed from the wellbore 618 to allow a logging tool 620 to be lowered by wireline 622, slickline, or logging other cable into the wellbore 618. Typically, the logging tool 620 is lowered to a region of interest and subsequently pulled upward at a substantially constant speed. During the upward trip, instruments included in the logging tool 620 may be used to perform measurements on the subterranean formation 624 adjacent the wellbore 618 as the logging tool 620 passes by.

The logging data may be communicated to a logging facility 628 for storage, processing, and analysis. The logging facility 628, shown in FIG. 6 as a truck, may be provided with electronic equipment for various types of signal processing including a control system or processor similar to processor 538 of FIG. 5 for performing the logging analysis methods described herein.

At various times during drilling, completing, and producing a well, well log data may be collected for a subterranean formation (e.g., 518). In some instances, the wellbore tools associated with a specific operation (e.g., a work string for perforating the formation) may be removed from the wellbore 618 to conduct measurement/logging operations. As illustrated in FIG. 6, the logging assembly 600 may include a one or more elemental analysis tools (e.g., 620) that may be suspended into the wellbore 618 by a cable (e.g., 622). The elemental analysis tools 620 may be communicably coupled to the cable 622. The cable 622 may include conductors for transporting power to the elemental analysis tools 620 and also facilitate communication between the surface and the elemental analysis tools 620. The logging facility 628 may collect measurements from the elemental analysis tools 620, and may include computing facilities (not shown) for controlling, processing, storing, and/or visualizing the measurements gathered by the elemental analysis tools 620. The computing facilities may be communicably coupled to the elemental analysis tools 620 by way of the cable 622. In some instances, the process 100 of FIG. 1 may be implemented using the computing facilities. Alternatively, the measurements gathered by the elemental analysis tools 620 may be transmitted (wired or wirelessly) or physically delivered to computing facilities off-site where the methods and processes described herein may be implemented.

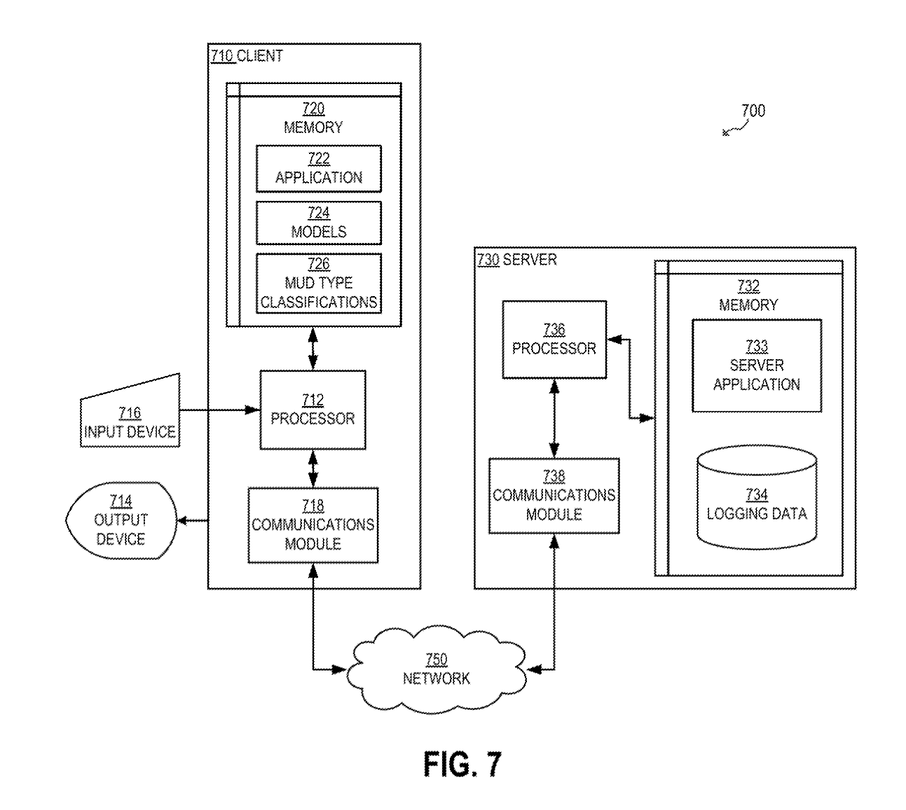

FIG. 7 is a block diagram 700 illustrating an example server 730 and client 710 in the architecture 700 of FIG. 7 according to certain aspects of the disclosure. The client 710 and the server 730 are connected over the network 750 via respective communications modules 718 and 738. The communications modules 718 and 738 are configured to interface with the network 750 to send and receive information, such as data, requests, responses, and commands to other devices on the network. The communications modules 718 and 738 can be, for example, modems or Ethernet cards.

The server 730 includes a memory 732, a processor 736, and a communications module 738. The memory 732 of the server 730 includes a server application 732. The processor 736 of the server 730 is configured to execute instructions, such as instructions physically coded into the processor 736, instructions received from software in the memory 732, or a combination of both. The memory 732 includes a server application 733. The processor 736 of the server 730 executes instructions from the server application 733 causing the processor 736 to process an elemental analysis log received from the client 710 over the network 750 in order to determine one or more unbiased (or bias-corrected) elemental concentrations of a subterranean formation. The memory 732 also includes logging data 734. The logging data 734 may include the logging measurements received from the client 710 over the network 750. In some aspects, the server 730 may correct a biased elemental analysis log by producing the bias-corrected elemental analysis log using borehole bias predictive modeling that may be stored in the logging data 734.

The client 710 includes a processor 712, the communications module 718, and the memory 720 that includes the application 722. The application 722 may be an elemental analysis tool, or physically coded instructions that execute a real-time analysis of geochemical logs produced by neutron-induced gamma ray spectroscopy in order to obtain elemental concentrations observed in the subterranean formation. The client 710 also includes an input device 716, such as a keyboard, mouse, touchscreen and/or game controller, and an output device 714, such as a display. The memory 720 also includes models 724 and mud type classifications 726. The models 724 may be the modeled tool responses such as borehole bias predictive models that predict a borehole bias vector based on a given atomic number density of the elemental component for a given borehole diameter. The mud type classifications 726 may identify a set of drilling muds applicable to the estimate of borehole corrections such as calcium-weighted oil-based mud, calcium-weighted water-based mud, barite-weighted oil-based mud, barite-weighted water-based mud, and others. The mud type classifications also may include an index of drilling mud properties that correspond to the different drilling muds.

The processor 712 of the client 710 is configured to execute instructions, such as instructions physically coded into the processor 712, instructions received from software in the memory 720, or a combination of both. The processor 712 of the client 710 executes instructions from the application 722 causing the processor 712 to run a process that estimates borehole corrections for calcium yields and sulfur yields in wells drilled with calcium-weighted oil- or water-based muds and/or barite-weighted oil- or water-based muds.

The processor 712, using the application 722, may obtain drilling mud properties that correspond to one of a plurality of mud type classifications. The processor 712, using the application 722, may correlate the drilling mud properties to elemental atomic number densities for the mud type classification. The processor 712, using the mud type classifications 726, may model a tool response for a plurality of logging conditions based on the elemental atomic number densities. The processor 712, using the models 724 and the mud type classifications 726, may determine a borehole bias vector from the modeled tool response. The processor 712, using the application 722, may obtain a relative elemental yield vector of a subterranean formation, in which the relative elemental yield vector includes a borehole signal bias. In one or more aspects, one or more elemental yield values in the relative elemental yield vector are biased by the borehole signal bias. The processor 712, using the application 722, may modify the relative elemental yield vector based on the borehole bias vector, in which the modified relative elemental yield vector excludes the borehole signal bias.

In some aspects, the processor 712, using the application 722, may determine bias-corrected elemental concentrations of the subterranean formation based on the modified relative elemental yield vector. For example, the processor 712, using the application 722, may determine a calcium yield bias value of the borehole bias vector, in which the calcium yield bias value is subtracted from a calcium yield value in the relative elemental yield vector so that a bias-corrected calcium concentration value may be produced. In another example, the processor 712, using the application 722, may determine a sulfur yield bias value of the borehole bias vector, in which the sulfur yield bias value is subtracted from a sulfur yield value in the relative elemental yield vector so that a bias-corrected sulfur concentration value may be produced.

In some aspects, the mud type classifications is a calcium-weighted oil-based mud, in which calcium yields and sulfur yields in the relative elemental yield vector are modified by the borehole bias vector. In some aspects, the mud type classification is a calcium-weighted water-based mud, in which calcium yields and sulfur yields in the relative elemental yield vector are modified by the borehole bias vector. In other aspects, the mud type classification is a barite-weighted oil-based mud, in which sulfur yield values in the relative elemental yield vector are modified by the borehole bias vector. In still other aspects, the mud type classification is a barite-weighted water-based mud, in which sulfur yields in the relative elemental yield vector are modified by the borehole bias vector.

In some aspects, the processor 712, using the application 722, may apply the borehole bias vector to the relative elemental yield vector to adjust a calcium yield value in the distribution of individual elemental yields. In other aspects, the processor 712, using the application 722, may apply the borehole bias vector to the relative elemental yield vector to adjust a sulfur yield value in the distribution of individual elemental yields. In some aspects, applying the borehole bias vector may include subtracting the borehole bias vector from the relative elemental yield vector.

In some aspects, the processor 712, using the application 722, may measure a gamma ray spectra signal from the subterranean formation, in which the gamma ray spectra signal is produced from one or more nuclear reactions occurring in the subterranean formation. In some aspects, the gamma ray spectra signal includes one or more borehole bias signals. The processor 712, using the application 722, may apply a weighted least-squares fitting distribution to the measured gamma ray spectra signal, in which the relative elemental yield vector is obtained based on the applied weighted least-squares fitting distribution. In one or more aspects, the relative elemental yield vector indicates a distribution of individual element concentrations in the subterranean formation.

In some aspects, the processor 712, using the application 722 and the mud type classifications 726, may modify one or more drilling mud properties for the mud type classification. The processor 712, using the application 722, may determine a function between a borehole bias distribution and an elemental atomic number density distribution for a given elemental concentration as a function of borehole diameter based on the modified one or more drilling mud properties. In some aspects, the processor 712, using the application 722 and the models 724, obtains the borehole bias vector from the function for a given borehole diameter based on a corresponding elemental atomic number density of the given elemental concentration. The function may include a linear function in some implementations, or may include a non-linear function in other implementations. For example, the function may include a quadratic function, a logarithmic function, or the like.

In other aspects, the processor 712, using the application 722 and the models 724, may select one of a plurality of borehole bias predictive models for the mud type classification. In some aspects, each of the plurality of borehole bias predictive models includes a function that indicates a relationship (e.g., a linear relationship when a linear function) between a borehole bias distribution and an elemental atomic number density distribution for the mud type classification. The processor 712 may receive user input values that correspond to the mud type classification via the input device 716. The processor 712, using the application 722, may apply the received user input values to drilling mud properties associated with the selected borehole bias predictive model. In some aspects, the borehole bias vector is obtained based on the applied user input values.

In some aspects, the modified relative elemental yield vector may be provided for display on the output device 714. In some aspects, the modified relative elemental yield vector is provided for display concurrently with the wellbore being drilled.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

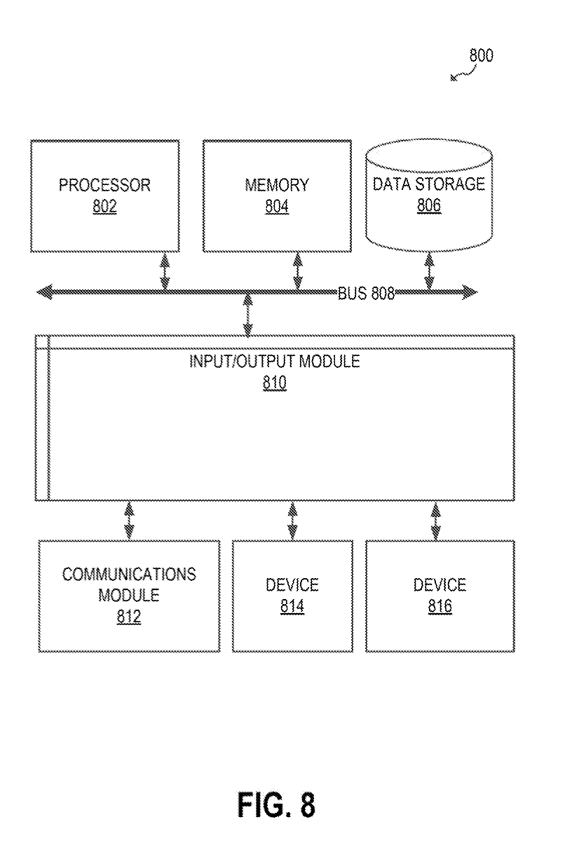

FIG. 8 is a block diagram illustrating an exemplary computer system 800 with which the client 710 and server 730 of FIG. 7 can be implemented. In certain aspects, the computer system 800 may be implemented using hardware or a combination of software and hardware, either in a dedicated server, integrated into another entity, or distributed across multiple entities.

Computer system 800 (e.g., client 710 and server 730) includes a bus 808 or other communication mechanism for communicating information, and a processor 802 (e.g., processor 712 and 736) coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, e.g., code that constitutes processor firmware, a protocol stack, a database management system, an operating system, or a combination of one or more of them stored in an included memory 804 (e.g., memory 720 and 732), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 808 for storing information and instructions to be executed by processor 802. The processor 802 and the memory 804 can be supplemented by, or incorporated in, special purpose logic circuitry.

The instructions may be stored in the memory 804 and implemented in one or more computer program products, i.e., one or more modules of computer program instructions encoded on a computer readable medium for execution by, or to control the operation of, the computer system 800, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled to bus 808 for storing information and instructions. Computer system 800 may be coupled via input/output module 810 to various devices. The input/output module 810 can be any input/output module. Exemplary input/output modules 810 include data ports such as USB ports. The input/output module 810 is configured to connect to a communications module 812. Exemplary communications modules 812 (e.g., communications modules 718 and 738) include networking interface cards, such as Ethernet cards and modems. In certain aspects, the input/output module 810 is configured to connect to a plurality of devices, such as an input device 814 (e.g., input device 716) and/or an output device 816 (e.g., output device 714). Exemplary input devices 814 include a keyboard and a pointing device, e.g., a mouse or a trackball, by which a user can provide input to the computer system 800. Other kinds of input devices 814 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 816 include display devices such as a LCD (liquid crystal display) monitor, for displaying information to the user.

According to one aspect of the present disclosure, the client 710 and server 730 can be implemented using a computer system 800 in response to processor 802 executing one or more sequences of one or more instructions contained in memory 804. Such instructions may be read into memory 804 from another machine-readable medium, such as data storage device 806. Execution of the sequences of instructions contained in the main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 750) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 800 can include clients and servers. A client and server are generally remote from each other and typically interact through a communication network. The relationship of client and server arises by virtue of computer programs running on the respective computers and having a client-server relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires that comprise bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

Various examples of aspects of the disclosure are described below. These are provided as examples, and do not limit the subject technology.

A method is provided that includes obtaining drilling mud properties that correspond to one of a plurality of mud type classifications. The method also includes correlating the drilling mud properties to elemental atomic number densities for the mud type classification. The method also includes modeling a tool response for a plurality of logging conditions based on the elemental atomic number densities. The method also includes determining a borehole bias vector from the modeled tool response. The method also includes obtaining a relative elemental yield vector of a subterranean formation, the relative elemental yield vector including a borehole signal bias, wherein one or more elemental yield values in the relative elemental yield vector are biased by the borehole signal bias. The method also includes modifying the relative elemental yield vector based on the borehole bias vector, the modified relative elemental yield vector excluding the borehole signal bias.

The method also includes determining bias-corrected elemental concentrations of the subterranean formation based on the modified relative elemental yield vector.

In determining the bias-corrected elemental concentrations, the method also includes determining a calcium yield bias value of the borehole bias vector, wherein the calcium yield bias value is subtracted from a calcium yield value in the relative elemental yield vector so that a bias-corrected calcium concentration value may be produced.

In determining the bias-corrected elemental concentrations, the method also includes determining a sulfur yield bias value of the borehole bias vector, wherein the sulfur yield bias value is subtracted from a sulfur yield value in the relative elemental yield vector so that a bias-corrected sulfur concentration value may be produced.

The mud type classification may be a calcium-weighted oil-based mud, in which calcium yields and sulfur yields in the relative elemental yield vector are modified by the borehole bias vector.

The mud type classification may be a calcium-weighted water-based mud, in which calcium yields and sulfur yields in the relative elemental yield vector are modified by the borehole bias vector.

The mud type classification may be a barite-weighted oil-based mud, in which sulfur yeild values in the relative elemental yield vector are modified by the borehole bias vector.

The mud type classification may be a barite-weighted water-based mud, in which sulfur yields in the relative elemental yield vector are modified by the borehole bias vector.

The method also includes drilling a wellbore penetrating the subterranean formation, the wellbore being drilled with a drilling mud corresponding to the mud type classification.

The method also includes logging the wellbore with an elemental analysis tool to produce an elemental analysis log, the elemental analysis log including a distribution of individual elemental concentrations of the subterranean formation.

A non-transitory computer readable storage medium including instructions that, when executed by a processor, cause the processor to perform a method. The method includes logging the wellbore with an elemental analysis tool to produce an elemental analysis log. The method also includes applying a weighted least-squares fitting distribution to the elemental analysis log to obtain a relative elemental yield vector of a subterranean formation, the relative elemental yield vector including a distribution of individual elemental yields of the subterranean formation and a borehole signal bias, wherein one or more elemental yield values in the relative elemental yield vector are biased by the borehole signal bias. The method also includes obtaining a borehole bias vector for a mud type classification. The method also includes removing the borehole signal bias from the relative elemental yield vector to produce a modified relative elemental yield vector based on the borehole bias vector, the modified relative elemental yield vector indicating one or more bias-corrected elemental concentrations of the subterranean formation.

In removing the borehole signal bias, the method also includes applying the borehole bias vector to the relative elemental yield vector to adjust a calcium yield value in the distribution of individual elemental yields.

In removing the borehole signal bias, the method also includes applying the borehole bias vector to the relative elemental yield vector to adjust a sulfur yield value in the distribution of individual elemental yields.

The method also includes applying the borehole bias vector comprises subtracting the borehole bias vector from the relative elemental yield vector.

In logging the wellbore, the method also includes measuring a gamma ray spectra signal from the subterranean formation, the gamma ray spectra signal being produced from one or more nuclear reactions occurring in the subterranean formation, the gamma ray spectra signal including one or more borehole bias signals.

The method also includes applying a weighted least-squares fitting distribution to the measured gamma ray spectra signal, wherein the relative elemental yield vector is obtained based on the applied weighted least-squares fitting distribution, the relative elemental yield vector indicating a distribution of individual element concentrations in the subterranean formation.

A system includes an elemental analysis tool, one or more processors, and a non-transitory computer-readable medium coupled to the elemental analysis tool to receive data from the elemental analysis tool and encoded with instructions that, when executed by the one or more processors, cause the one or more processors to perform operations. The operations include obtaining a relative elemental yield vector of the subterranean formation from the elemental analysis log, the relative elemental yield vector including a borehole signal bias, wherein one or more elemental yield values in the relative elemental yield vector are biased by the borehole signal bias. The operations also include obtaining a borehole bias vector for the mud type classification. The operations also include removing the borehole signal bias from the relative elemental yield vector to produce a modified relative elemental yield vector based on the borehole bias vector, the modified relative elemental yield vector indicating one or more bias-corrected elemental concentrations in the subterranean formation.

The system also includes a display device coupled to the one or more processors. In this respect, the operations also include providing, for display, the modified relative elemental yield vector on the display device.

The operations also include drilling a wellbore penetrating the subterranean formation, the wellbore being drilled with a drilling mud corresponding to the mud type classification.

The modified relative elemental yield vector may be provided for display concurrently with the wellbore being drilled.

The operations also include modifying one or more drilling mud properties for the mud type classification, and determining a function between a borehole bias distribution and an elemental atomic number density distribution for a given elemental concentration as a function of borehole diameter based on the modified one or more drilling mud properties, in which the borehole bias vector is obtained from the function for a given borehole diameter based on a corresponding elemental atomic number density of the given elemental concentration.

The operations also include logging the wellbore with the elemental analysis tool to produce the elemental analysis log, in which the elemental analysis log includes a distribution of individual elemental concentrations of the subterranean formation.

The operations also include selecting one of a plurality of borehole bias predictive models for the mud type classification, each of the plurality of borehole bias predictive models including a function that indicates a relationship between a borehole bias distribution and an elemental atomic number density distribution for the mud type classification. The operations also include receiving user input values that correspond to the mud type classification, and applying the received user input values to drilling mud properties associated with the selected borehole bias predictive model, wherein the borehole bias vector is obtained based on the applied user input values.

The operations also include indexing each of the plurality of borehole bias predictive models in a data repository based on a given mud type classification.

In one or more aspects, examples of clauses are described below.

A method comprising one or more methods, operations or portions thereof described herein.

An apparatus comprising one or more memories and one or more processors (e.g., 710), the one or more processors configured to cause performing one or more methods, operations or portions thereof described herein.

An apparatus comprising one or more memories (e.g., 720, one or more internal, external or remote memories, or one or more registers) and one or more processors (e.g., 712) coupled to the one or more memories, the one or more processors configured to cause the apparatus to perform one or more methods, operations or portions thereof described herein.

An apparatus comprising means (e.g., 710) adapted for performing one or more methods, operations or portions thereof described herein.

A processor (e.g., 712) comprising modules for carrying out one or more methods, operations or portions thereof described herein.

A hardware apparatus comprising circuits (e.g., 710) configured to perform one or more methods, operations or portions thereof described herein.

An apparatus comprising means (e.g., 710) adapted for performing one or more methods, operations or portions thereof described herein.

An apparatus comprising components (e.g., 710) operable to carry out one or more methods, operations or portions thereof described herein.

A computer-readable storage medium (e.g., 720, one or more internal, external or remote memories, or one or more registers) comprising instructions stored therein, the instructions comprising code for performing one or more methods or operations described herein.

A computer-readable storage medium (e.g., 720, one or more internal, external or remote memories, or one or more registers) storing instructions that, when executed by one or more processors, cause one or more processors to perform one or more methods, operations or portions thereof described herein.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

Therefore, the subject technology is well adapted to attain the ends and advantages mentioned as well as those that are inherent therein. The particular embodiments disclosed above are illustrative only, as the subject technology may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the subject technology. The subject technology illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method, comprising:
obtaining mud properties that correspond to one of a plurality of mud type classifications;
correlating the mud properties to elemental atomic number densities for the mud type classification;
modeling a tool response for a plurality of logging conditions based on the elemental atomic number densities;
determining a borehole bias vector from the modeled tool response;
obtaining a relative elemental yield vector of a subterranean formation, the relative elemental yield vector including a borehole signal bias, wherein one or more elemental yield values in the relative elemental yield vector are biased by the borehole signal bias; and
modifying the relative elemental yield vector based on the borehole bias vector, the modified relative elemental yield vector excluding the borehole signal bias.

2. The method of claim 1, further comprising:
determining bias-corrected elemental concentrations of the subterranean formation based on the modified relative elemental yield vector.

3. The method of claim 2, wherein determining the bias-corrected elemental concentrations comprises:
determining a calcium yield bias value of the borehole bias vector, wherein the calcium yield bias value is subtracted from a calcium yield value in the relative elemental yield vector to obtain a bias-corrected calcium concentration value.

4. The method of claim 2, wherein determining the bias-corrected elemental concentrations comprises:
determining a sulfur yield bias value of the borehole bias vector, wherein the sulfur yield bias value is subtracted from a sulfur yield value in the relative elemental yield vector to obtain a bias-corrected sulfur concentration value.

5. The method of claim 1, wherein the mud type classification is a calcium-weighted oil-based mud, and wherein calcium yields and sulfur yields in the relative elemental yield vector are modified by the borehole bias vector.

6. The method of claim 1, wherein the mud type classification is a calcium-weighted water-based mud, and wherein calcium yields and sulfur yields in the relative elemental yield vector are modified by the borehole bias vector.

7. The method of claim 1, wherein the mud type classification is a barite-weighted oil-based mud, and wherein sulfur yield values in the relative elemental yield vector are modified by the borehole bias vector.

8. The method of claim 1, wherein the mud type classification is a barite-weighted water-based mud, and wherein sulfur yields in the relative elemental yield vector are modified by the borehole bias vector.

9. The method of claim 1, further comprising:
drilling a wellbore penetrating the subterranean formation, the wellbore being drilled with a drilling mud corresponding to the mud type classification.

10. The method of claim 9, further comprising:
logging the wellbore with an elemental analysis tool to produce an elemental analysis log, the elemental analysis log including a distribution of individual elemental concentrations of the subterranean formation.

11. A non-transitory computer readable storage medium including instructions that, when executed by a processor, cause the processor to perform a method, the method comprising:
logging the wellbore with an elemental analysis tool to produce an elemental analysis log;
applying a weighted least-squares fitting distribution to the elemental analysis log to obtain a relative elemental yield vector of a subterranean formation, the relative elemental yield vector including a distribution of individual elemental yields of the subterranean formation and a borehole signal bias, wherein one or more elemental yield values in the relative elemental yield vector are biased by the borehole signal bias;
obtaining a borehole bias vector for a mud type classification; and
removing the borehole signal bias from the relative elemental yield vector to produce a modified relative elemental yield vector based on the borehole bias vector, the modified relative elemental yield vector indicating one or more bias-corrected elemental concentrations of the subterranean formation.

12. The non-transitory computer readable storage medium of claim 11, wherein removing the borehole signal bias comprises:
applying the borehole bias vector to the relative elemental yield vector to adjust a calcium yield value in the distribution of individual elemental yields.

13. The non-transitory computer readable storage medium of claim 11, wherein removing the borehole signal bias comprises:
applying the borehole bias vector to the relative elemental yield vector to adjust a sulfur yield value in the distribution of individual elemental yields.

14. The non-transitory computer readable storage medium of claim 11, wherein applying the borehole bias vector comprises subtracting the borehole bias vector from the relative elemental yield vector.

15. The non-transitory computer readable storage medium of claim 11, wherein logging the wellbore comprises:
measuring a gamma ray spectra signal from the subterranean formation, the gamma ray spectra signal being produced from one or more nuclear reactions occurring in the subterranean formation, the gamma ray spectra signal including one or more borehole bias signals.

16. The non-transitory computer readable storage medium of claim 15, wherein the method further comprises:
applying a weighted least-squares fitting distribution to the measured gamma ray spectra signal, wherein the relative elemental yield vector is obtained based on the applied weighted least-squares fitting distribution, the relative elemental yield vector indicating a distribution of individual element concentrations in the subterranean formation.

17. A system comprising:
an elemental analysis tool;
one or more processors; and
a non-transitory computer-readable medium coupled to the elemental analysis tool to receive data from the elemental analysis tool and encoded with instructions that, when executed by the one or more processors, cause the one or more processors to perform operations comprising:
obtaining a relative elemental yield vector of a subterranean formation from an elemental analysis log, the relative elemental yield vector including a borehole signal bias, wherein one or more elemental yield values in the relative elemental yield vector are biased by the borehole signal bias;
obtaining a borehole bias vector for one of a plurality of mud type classifications; and
removing the borehole signal bias from the relative elemental yield vector to produce a modified relative elemental yield vector based on the borehole bias vector, the modified relative elemental yield vector indicating one or more bias-corrected elemental concentrations in the subterranean formation.

18. The system of claim 17, further comprising:
a display device coupled to the one or more processors,
wherein the operations further comprise:
providing, for display, the modified relative elemental yield vector on the display device.

19. The system of claim 17, wherein the operations further comprise:
drilling a wellbore penetrating the subterranean formation, the wellbore being drilled with a drilling mud corresponding to the mud type classification.

20. The system of claim 19, wherein the modified relative elemental yield vector is provided for display concurrently with the wellbore being drilled.

21. The system of claim 19, wherein the operations further comprise:
modifying one or more drilling mud properties for the mud type classification; and
determining a function between a borehole bias distribution and an elemental atomic number density distribution for a given elemental concentration as a function of borehole diameter based on the modified one or more drilling mud properties, wherein the borehole bias vector is obtained from the function for a given borehole diameter based on a corresponding elemental atomic number density of the given elemental concentration.

22. The system of claim 17, wherein the operations further comprise:
logging a wellbore with the elemental analysis tool to produce the elemental analysis log, the elemental analysis log including a distribution of individual elemental concentrations of the subterranean formation.

23. The system of claim 17, wherein the operations further comprise:
selecting one of a plurality of borehole bias predictive models for the mud type classification, each of the plurality of borehole bias predictive models including a function that indicates a relationship between a borehole bias distribution and an elemental atomic number density distribution for the mud type classification;
receiving user input values that correspond to the mud type classification; and
applying the received user input values to drilling mud properties associated with the selected borehole bias predictive model, wherein the borehole bias vector is obtained based on the applied user input values.

24. The system of claim 23, wherein the operations further comprise:
indexing each of the plurality of borehole bias predictive models in a data repository based on a given mud type classification.
